(19) United States
(12) Patent Application Publication
(10) Pub. No.: US 2012/0107028 A1
(43) Pub. Date: May 3, 2012

(54) INDUCTION HEATING UNIT, FIXING APPARATUS, AND IMAGE FORMING APPARATUS

(75) Inventor: Yoshiyuki Mizumo, Kaizuka-shi (JP)

(73) Assignee: Konica Minolta Business Technologies, Inc., Chiyoda-ku (JP)

(21) Appl. No.: 13/253,471

(22) Filed: Oct. 5, 2011

(30) Foreign Application Priority Data
Oct. 29, 2010 (JP) 2010-243429

(51) Int. Cl. G03G 15/20

(52) U.S. Cl. 399/328

(57) ABSTRACT

A magnetizing coil and a demagnetizing coil are disposed in a fixing apparatus that uses electromagnetic induction to heat a conductive heat-producing rotating body and thermally fixes a toner image onto a recording sheet in one of a plurality of sizes. The magnetizing coil is arranged along the outer surface of the rotating body and heats the rotating body through electromagnetic induction heating. The demagnetizing coil is arranged in partially-overlapping proximity to the magnetizing coil and suppresses overheating in a non-sheet-passing region of the rotating body by partially canceling out the flux produced by the magnetizing coil when fixing is performed on a small sheet. The demagnetizing coil is a coil pattern printed on a flexible substrate, and the wire width thereof is wider than the inter-wire distance of neighboring portions of the wire.

### CROSS-REFERENCE TO RELATED APPLICATIONS

This application is based on application No. 2010-243429 filed in Japan, the contents of which are hereby incorporated by reference.

### BACKGROUND OF THE INVENTION

(1) Field of the Invention

The present invention relates to an induction heating unit, a fixing apparatus, and an image forming apparatus. In particular, the present invention relates to technology for preventing overheating in a non-sheet-passing region within an electrophotographic image forming apparatus that fixes toner images to a recording sheet through electromagnetic induction heating, while miniaturizing the induction heating unit.

(2) Description of the Related Art

In recent years, electrophotographic image forming apparatuses that thermally fix a toner image to a recording sheet using electromagnetic thermal heating have been developed, with the aims of decreasing electricity consumption and reducing warm-up times. In a fixing apparatus using electromagnetic induction heating, an induction heating layer is provided to a heating member that heats the toner image. An alternating magnetic field, produced by a magnetizing coil facing the induction heating layer, causes Joule heating therein by supplying induction current.

When the electromagnetic induction heating fixing apparatus has recording sheets of varying sizes pass therethrough, a non-passing-region is created corresponding to the size of a given recording sheet. The heating member causes electromagnetic induction heating in the non-sheet-passing region just as in the sheet-passing region. However, there is no cooling effect from the passing of the recording sheet. As a result, over successive passes, the non-sheet-passing region becomes overheated. This may lead to breakage or heat damage in the heating member or surrounding members.

Therefore, technology is being developed to, for example, provide a demagnetizing coil overlaid on the magnetizing coil at a position corresponding to the non-sheet-passing region, so as to open and close the demagnetizing coil according to the size of the recording sheet being passed. According to this technology, when a small recording sheet is passed, overheating is prevented in the non-sheet-passing region by using the demagnetizing coil to partially cancel out the magnetic field produced by the magnetizing coil (For reference, see, for example, Japanese Patent Application Publication No. 2009-258261 or Japanese Patent Application Publication No. 2009-271304).

However, the inclusion of a demagnetizing coil leads to a problematic size increase in the fixing apparatus.

Also, in order to increase the productivity of the image forming apparatus, higher fixing speeds whereby a greater number of recording sheets can be fixed per unit time, are sought. However, in order to increase the fixing speed, the heating by the magnetizing coil must be intensified to compensate for the cooling effect of the recording sheets passing through the sheet-passing region. Unfortunately, intensified output from the magnetizing coil causes accelerated heating in the non-passing region. As such, improvement is desired in the demagnetizing properties of the demagnetizing coil.

Furthermore, the cost increases associated with the addition of the demagnetizing coil must be constrained to a minimum.

### SUMMARY OF THE INVENTION

In consideration of the above problems, the present invention aims to provide an induction heating unit, a fixing apparatus, and an image forming apparatus that are small in size and feature great demagnetizing attributes, at low cost.

In order to achieve this aim, a fixing apparatus that uses electromagnetic induction to heat a conductive heat-producing rotating body and that thermally fixes a toner image onto a recording sheet in one of a plurality of sizes, comprises a magnetizing coil arranged along an outer circumferential surface of the heat-producing rotating body that heats the heat-producing rotating body through electromagnetic induction heating; and a demagnetizing coil arranged in partially-overlapping proximity to the magnetizing coil that suppresses overheating in a non-sheet-passing region of the heat-producing rotating body by partially canceling out magnetic flux produced by the magnetizing coil when fixing is performed on a small-size recording sheet, wherein the demagnetizing coil is a coil pattern printed on a flexible substrate, and the coil pattern has wires of greater width than the separation between neighboring portions of the wire.

### BRIEF DESCRIPTION OF THE DRAWINGS

These and other objects, advantages and features of the invention will become apparent from the following description thereof taken in conjunction with the accompanying drawings those illustrate a specific embodiments of the invention.

In the drawings:

FIG. 1 shows the principal configuration of an image forming apparatus pertaining to an Embodiment of the present invention;

FIG. 2 is a cross-sectional diagram showing the principal configuration of a fixing apparatus 115;

FIG. 3 is a cross-sectional diagram showing the configuration of a fixing belt 206;

FIG. 4 is a cross-sectional diagram showing the configuration of an induction heating unit 200;

FIG. 5 is an exploded perspective view displaying the positional relationship between a magnetizing coil 207 and demagnetizing coils 215;

FIG. 6 shows the circuit configuration used to control the magnetizing coil 207 and the demagnetizing coils 215;

FIG. 7 is a plan view showing the simplified configuration of the demagnetizing coils 215;

FIG. 8A is an exploded diagram showing the configuration of a printed coil set 700, and FIG. 8B is a partial expanded view showing the configuration of the printed coil set 700;

FIG. 9 is an expanded view of a portion of a coil pattern wire 701;

FIG. 10 is a cross-sectional diagram showing the structure of a printed coil 800;

FIG. 11 is a cross-sectional diagram showing the structure of a connecting electrode 702;

FIG. 12 is a graph showing the properties of magnetic fields produced by the induction heating unit 200 under various conditions;

FIGS. 13A and 13B are graphs showing the relationship between the number of connected printed coils 800 and the inductance, where the coils are connected in parallel for FIG. 13A and in series for FIG. 13B;

FIG. 14 is a cross-sectional diagram showing the structure of a printed coil 800 pertaining to a variation of the present invention;

FIG. 15 is a cross-sectional diagram showing the configuration of an induction heating unit 200 pertaining to a variation of the present invention;

FIG. 16 is a plan view showing the simplified configuration of demagnetizing coils 215 pertaining to a variation of the present invention; and

FIGS. 17A and 17B respectively show, in a plan view, the printed coil set 700 before and after processing for adhesion of the magnetizing coil 207.

### DESCRIPTION OF PREFERRED EMBODIMENTS

An Embodiment of the present invention pertaining to an induction heating unit, a fixing apparatus, and an image forming apparatus is described below with reference to the drawings.

### 1. IMAGE FORMING APPARATUS CONFIGURATION

First of all, the configuration of the image forming apparatus pertaining to the present Embodiment is described.

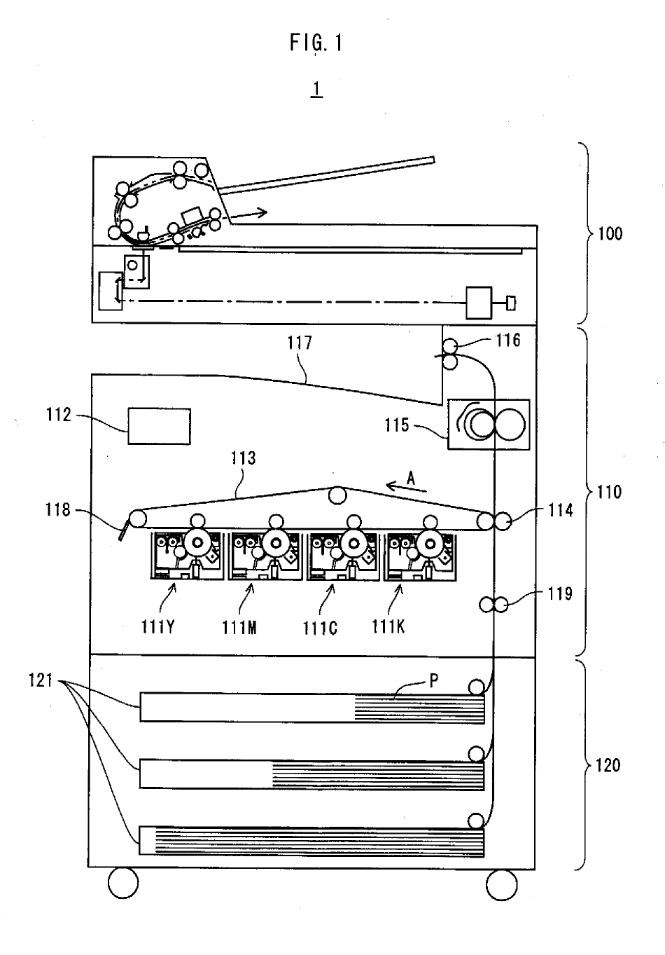

FIG. 1 shows the principal configuration of the image forming apparatus pertaining to the present Embodiment. As shown, the image forming apparatus 1 includes a document read unit 100, an image formation unit 110, and a take-up unit 120. The document read unit 100 generates image data by optically reading a document through an Automatic Document Feeder (ADF) that takes a document placed on a document tray. The image data are stored in a later-described control unit 112.

The image formation unit 110 includes imaging units 111Y, 111M, 111C, 111K, the control unit 112, an intermediate transfer belt 113, a pair of secondary transfer rollers 114, a fixing apparatus 115, a pair of exit rollers 116, an exit tray 117, a cleaner 118, and a pair of timing rollers 119.

Each of the imaging units 111Y, 111M, 111C, 111K is controlled by the control unit 112 and forms a toner image in a respective color, i.e., yellow (Y), magenta (M), cyan (C), or black (K). The toner images in the respective colors undergo a static transfer (primary transfer), so as to be overlaid on the intermediate transfer belt 113. The intermediate transfer belt 113 is an endless rotating body that rotates in the direction shown by arrow A and carries the toner image resulting from the primary transfer to the secondary transfer rollers 114.

The take-up unit 120 includes take-up cassettes 121 that contains recording sheets P in each of several paper sizes, and supplies one of the recording sheets P to the image formation unit 110. While the toner images are carried by the intermediate transfer belt 113, the supplied recording sheet P is carried through the timing rollers 119 to reach the secondary transfer rollers 114. The timing rollers 119 are a pair of rollers that adjust the timing at which the recording sheet P reaches the secondary transfer rollers 114.

The secondary transfer rollers 114 are a pair of rollers, each at a different voltage, pressed against each other so as to form a transfer nip. The toner image on the intermediate transfer belt 113 undergoes a static transfer (secondary transfer) onto the recording sheet P at the transfer nip. The recording sheet P, with the toner image having been transferred thereto, is carried to the fixing apparatus 115. After the secondary transfer, any toner remaining on the intermediate transfer belt 113 is scraped off by the cleaner 118 upon being carried by further travel in the direction of arrow A, and discarded.

The fixing apparatus 115 is an electromagnetic induction heater that heats the toner image for fusion by pressurization onto the recording sheet P. The recording sheet P with the toner image fused thereto is then made to exit onto the exit tray 117 by the exit rollers 116. The control unit 112 controls the operations of the image forming apparatus 1, including those described above.

### 2. FIXING APPARATUS 115 CONFIGURATION

The configuration of the fixing apparatus 115 is explained next.

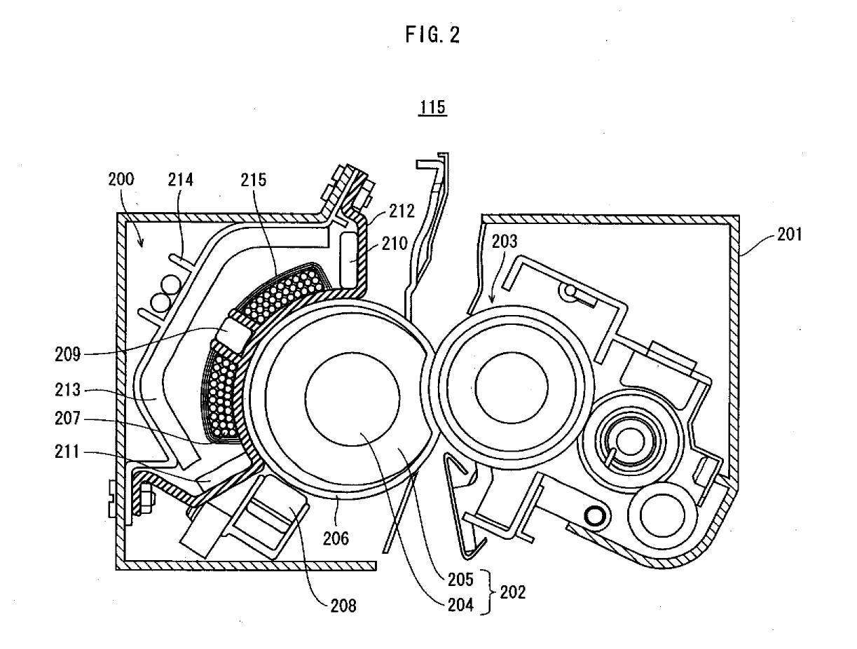

FIG. 2 is a cross-sectional diagram showing the principal configuration of the fixing apparatus 115. As shown, the fixing apparatus 115 includes a casing 201 that contains a fixing roller 202, a pressurizing roller 203, a fixing belt 206, an infrared (IR) sensor 208, and the induction heating unit 200.

The fixing roller 202 and the pressurizing roller 203 are both cylindrical rotating bodies, arranged such that the axes of rotation are parallel. The fixing roller 202 is made up of a core bar 204 with an insulating elastic layer 205 made of silicone sponge or similar formed over the outer surface thereof. The endless fixing belt 206 fits with slack over the fixing roller 202. The material of the core bar 204 may be, for example, non-magnetic stainless steel.

The pressurizing roller 203 is, for example, made up of a core bar with an elastic layer, a metallic layer, and a release layer layered thereon in the stated order. Any of electroformed Ni, stainless steel, an Fe alloy, an Al alloy, Cu alloy, or similar may be used. For the release layer, any of PFA resin powder, PFA dispersion paint, PFA/PFTE compound dispersion paint, or a PFA tube may be used. As such, toner is prevented from adhering to the pressurizing roller 203, thus improving image quality. For the elastic layer, any silicone rubber or silicone sponge having low thermal conductivity may be used. As such, dispersion of heat from the metallic layer to the core bar is prevented, and the power consumption of the fixing apparatus is constrained.

The pressurizing roller 203 is pressed into the fixing belt 206 by a non-diagrammed pressurizing mechanism. Accordingly, the nip width required for fixing is mainly preserved by deformation of the insulating elastic layer 205 of the fixing roller 202. The pressurizing roller 203 is driven to rotate by a non-diagrammed drive motor. The fixing belt 206 is, in turn, driven by pressure and friction from the pressurizing roller 203. The fixing roller 202 is also made to rotate, following the rotation of the fixing belt 206. Accordingly, the toner image is fixed as the recording sheet P is carried.

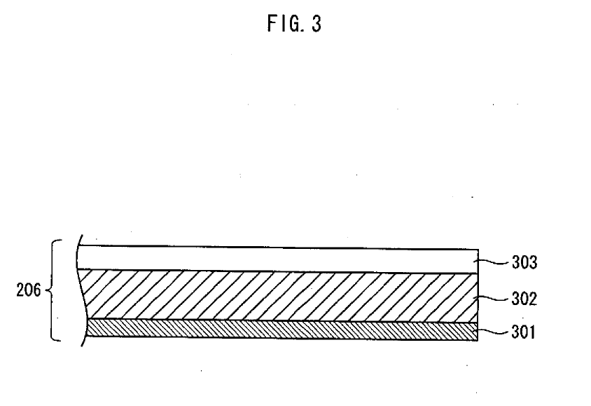

As shown in FIG. 3, the fixing belt 206 is made up of a metallic heating layer 301, an elastic layer 302, and a release layer 303, layered in the stated order of proximity to the fixing roller 202. The metallic heating layer 301 is composed of an electroformed Ni sleeve, and undergoes Joule heating due to the induction current produced by the alternating magnetic flux generated by the induction heating unit 200 passing therethrough. The elastic layer 302 is composed of silicone rubber. The release layer 303 is a PFA resin tube.

The IR sensor 208 is disposed in proximity to the outer surface of the fixing belt 206 so as to measure the surface temperature at the near-center of the axis of rotation of the fixing belt 206, without direct contact. The control unit 112 receives a temperature signal from the IR sensor 208 and controls the alternating flux produced by the induction heating unit 200 such that the fixing belt 206 remains at a predetermined fixing temperature.

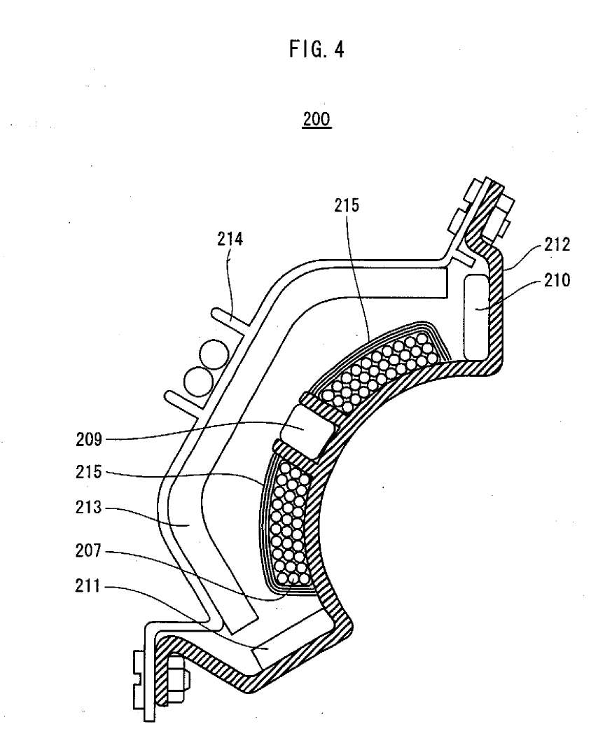

As shown in FIG. 4, the induction heating unit 200 includes a magnetizing coil 207, demagnetizing coils 215, a center core 209, a main core 213, hem cores 210 and 211, a coil bobbin 212, and a core holding member 214. The magnetizing coil 207, the center core 209, and the hem cores 210 and 211 are held in the coil bobbin 212. The main core 213 is held by the core holding member 214. The demagnetizing coils 215 are in contact with the magnetizing coil 207, being attached thereto. The coil bobbin 212 and the core holding member 214 are screwed onto to the casing 201 of the fixing apparatus 115.

The magnetizing coil 207 has an active heating length that matches the sheet-passing width of the largest recording sheet size handled by the image forming apparatus 1. The active heating length is the size of the area of the fixing belt 206 that can be heated up to the fixing temperature, and describes a length with respect to the axis of rotation of the fixing belt 206.

The center core 209, the hem cores 210 and 211, and the main core 213 are magnetic bodies having high permeability and low loss, made of an alloy such as ferrite or permalloy. The cores form a magnetic circuit in combination with the fixing belt 206 and the magnetizing coil 207. Accordingly, flux leakage outside the magnetic circuit is screened, thus improving thermal efficacy.

The magnetizing coil 207 is connected to a non-diagrammed high-frequency inverter and generates an alternating magnetic field from the high-frequency electric power supplied thereto, at 10 to 100 kHz and 100 to 2000 W. To this end, the magnetizing coil 207 ideally has litz wire winding therearound. These litz wires are bundles of fine copper wire, covered in heat-resistant resin. In the present Embodiment, the individual wires have a diameter of 0.17 mm, and 114 wires, twisted together into a single litz wire, are wound around the magnetizing coil 207 for 10 turns.

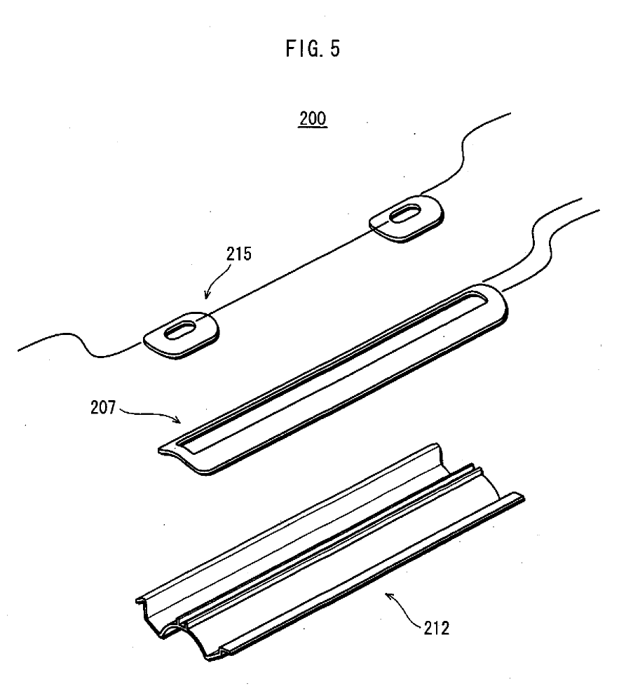

Also, the demagnetizing coils 215 are respectively disposed at either edge of the fixing belt 206, with respect to the axis of rotation, at positions above the magnetizing coil 207 corresponding to the non-sheet-passing region for a small paper size. FIG. 5 is an exploded perspective view indicating the positional relationship between the magnetizing coil 207 and the demagnetizing coils 215. As shown, the demagnetizing coils 215 are disposed at either end of the magnetizing coil 207 in the longitudinal direction. Also, as shown in FIG. 4, the demagnetizing coils 215 cover the outside of the magnetizing coil 207 relative to the circumferential direction of the fixing belt 206.

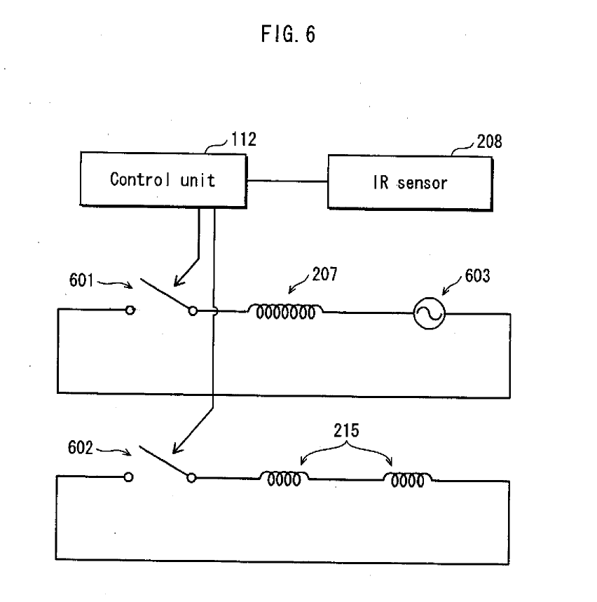

FIG. 6 shows the circuit configuration used to control the magnetizing coil 207 and the demagnetizing coils 215. As shown, the magnetizing coil 207 is connected to a high-frequency inverter 603 through a switching relay 601. Also, the demagnetizing coils 215 form a loop circuit connected in series to the switching relay 602. The switching relays 601 and 602 are both under the control of the control unit 112.

At image formation time, the control unit 112 switches the switching relay 601 to ON, thus energizing the magnetizing coil 207 to perform electromagnetic induction heating. Meanwhile, the control unit 112 has the IR sensor 208 monitor the temperature of the non-sheet-passing region. Once the non-sheet-passing region reaches the predetermined temperature, the switching relay 602 is switched ON and the demagnetizing coils 215 are made to produce an inverse flux. The flux produced by the magnetizing coil 207 is thereby canceled out, thus controlling the heating of the non-sheet-passing region.

The main core 213 is bent into a trapezoidal shape so as to cover the outer surface of the magnetizing coil 207. Up to a dozen or so main cores 213, disposed at equal intervals along a direction parallel to the axial direction of the fixing roller 202, are held by the core holding member 214. A non-total plurality of the main cores 213 are disposed at either end with respect to the axial direction raising the magnetic coupling of the ends in order to supplement the dispersion of heat from the ends of the fixing belt 206.

Also, the center core 209 and the hem cores 210 and 211 are each formed so as to be elongated in a direction parallel to the axis of rotation of the fixing roller 202. The cores are attached to the coil bobbin 212 by a silicon adhesive or similar heat-resistant adhesive. The hem cores 210 and 211 may be discrete with respect to the axial direction, but must be aligned such that no gaps are present.

The center core 209 guides the flux produced by the magnetizing coil 207 to the fixing belt 206 so as to achieve a uniform flux density. Eddy currents are induced in the fixing belt 206 by the flux passing therethrough. The fixing belt 206 thus undergoes Joule heating. The coil bobbin 212 and the core holding member 214 are attached by nuts and bolts in the hem portions thereof. The nuts and bolts may be replaced by rivets or the like.

### 3. DEMAGNETIZING COIL 215 STRUCTURE

The structure of the demagnetizing coils 215 is described next.

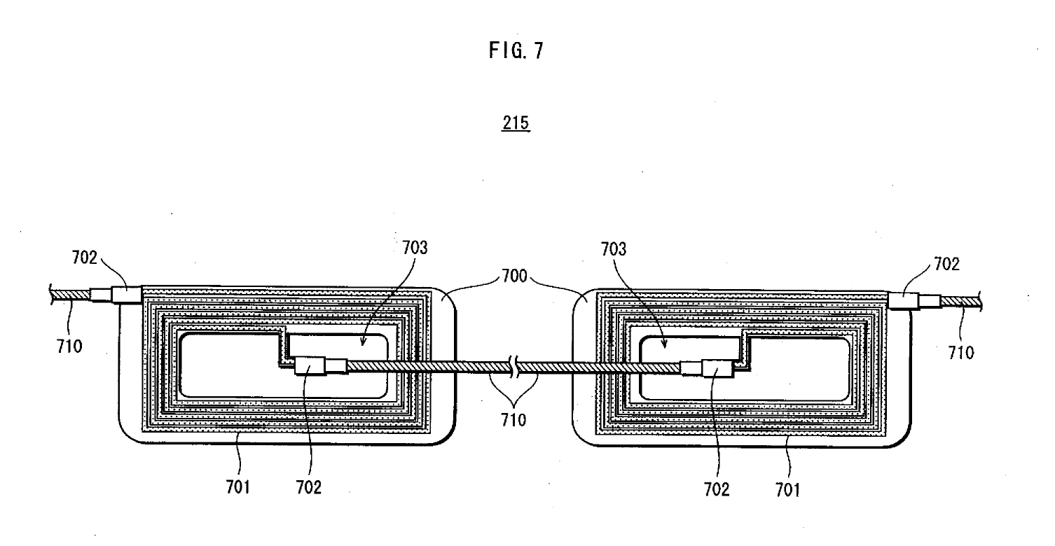

FIG. 7 is a plan view showing the simplified configuration of one of the demagnetizing coils 215. As shown, the demagnetizing coils 215 each include a pair of printed coil sets 700 electrically connected in parallel by a wiring cable 710. Each printed coil set 700 has a pair of connecting electrodes 702 formed along the diagonal thereof. A generally rectangular opening 703 is provided at the center of each printed coil set 700. A later-described coil pattern wire 701 is formed so as to wind around opening 703.

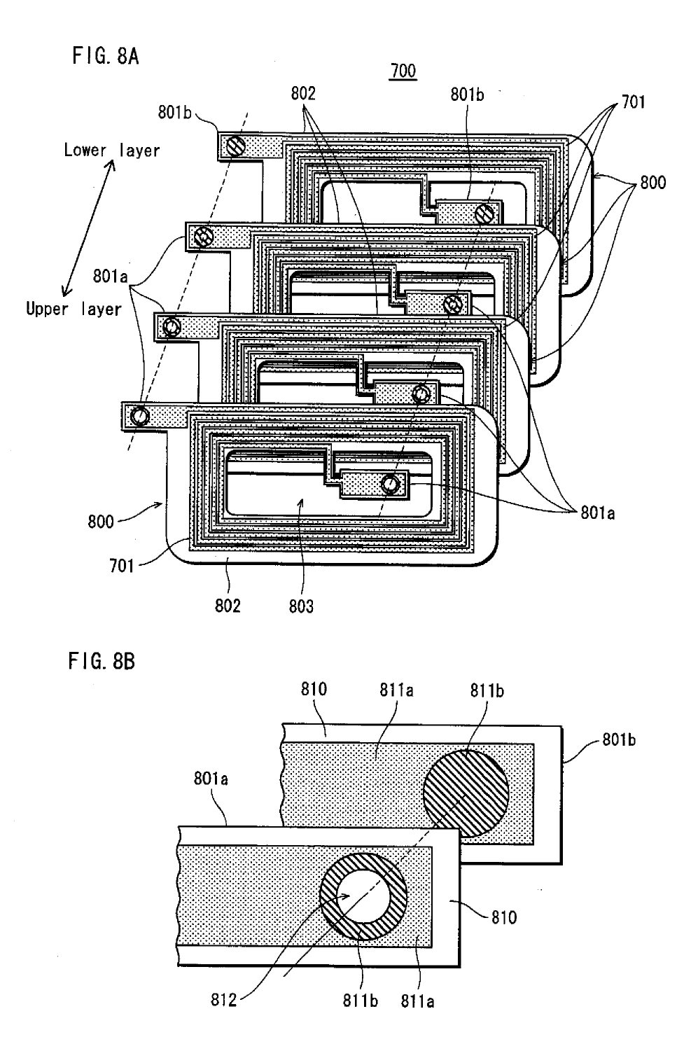

FIGS. 8A and 8B shows the configuration of the printed coil set 700. FIG. 8A is an exploded diagram, and FIG. 8B is a partial expanded view. As shown in FIG. 8A, the printed coil set 700 is made up of four overlaid printed coils 800. One printed coil 800 has a polyimide film 802 as a substrate, being generally rectangular as seen in a plan view. Also, a generally-rectangular opening 803 is provided in the central portion of the substrate, corresponding to the opening 703. A coil pattern wire 701 is formed on each of the printed coils 800.

Each of the printed coils 800 has a pair of connecting electrodes 801. The pair of connecting electrodes 801 is disposed along the diagonal of the printed coil 800. The connecting electrodes 702 are formed by overlaying the connecting electrodes 801 of each of the printed coils. As shown in FIG. 8B, the connecting electrodes 702 are formed by a wire 811 on the polyimide film 802. The wire 811 has an insulation-covered portion 811a and an exposed portion 811b. The wire 811 is connected to the coil pattern wire 701 and to the wiring cable 710.

The connecting electrodes 801 differ in shape depending on the position taken by the printed coil 800 within the printed coil set 700. To be precise, the connecting electrodes 801b of the printed coil 800 at the lowest position have no opening, whereas the connecting electrodes 801a of all other printed coils 800 have an opening 812 provided therein.

In the present Embodiment, the opening 812 is generally circular, as are the exposed wire portions 811b of the connecting electrodes 801b. Also, the exposed wire portion 811b of the connecting electrodes 801 is generally annular. Furthermore, the centers of the opening 812 and the exposed wire portion 811b substantially coincide. The diameter of the opening 812 of the connecting electrode 801 is larger for the higher-level connecting electrodes 801 and smaller for the lower-level connecting electrodes 801. In addition, the exposed wire portion 811b of the lower layers is visible through the opening 812 of the higher-level connecting electrode 801 when the connecting electrodes 801 of the lower layers are overlaid with the connecting electrodes 801 of the higher layers.

Given this shape, when all of the connecting electrodes are overlaid and seen in a plan view, the exposed wire portions 811b of the connecting electrodes 801 of all other layers are visible through the opening 812 of each connecting electrodes 801 of the topmost layer. Accordingly, when all of the connecting electrodes 801 are overlaid and soldered, all of the wire portions 811 are connectable.

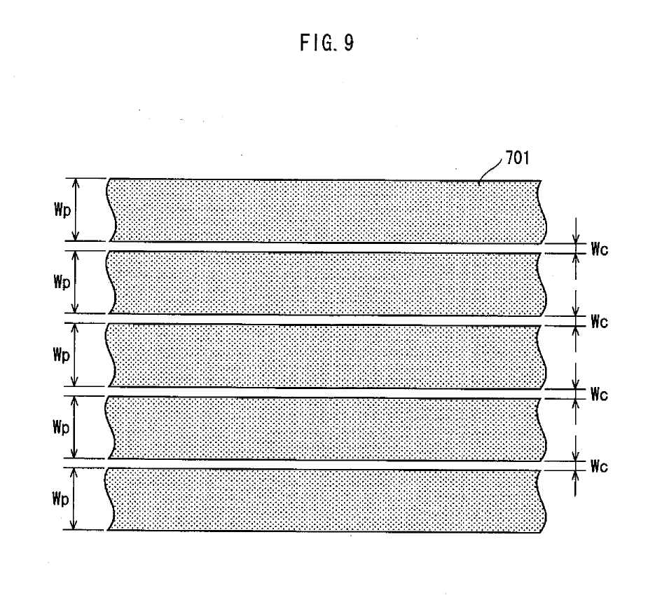

The coil pattern wire 701 is formed by etching approximately five turns of a spiral-shaped copper-plated wire onto the polyimide film 802 serving as the substrate of the printed coil 800. FIG. 9 is an expanded view of a portion of the coil pattern wire 701. As shown, the coil pattern wire 701 disposed flatly on the printed substrate is larger than the inter-wire distance Wc separating neighbouring wires of width Wp. Each of the coil pattern wires has a plate-like shape and a thickness that is less than Wp. In the present Embodiment, the wire width Wp is 2.5 mm and the inter-wire distance Wc is 0.2 mm. Thus, the inter-wire distance Wc narrows as the wire width Wp expands. This allows effective demagnetization of the magnetic field produced by the magnetizing coil 207. Also, the wire resistance is constrainable by widening the wire width Wp. This enables enhanced heat resistance for the demagnetizing coils 215. Further, rather than Cu, any of Al, Ag, Au, and so on may be used as the material for the coil pattern wire 701.

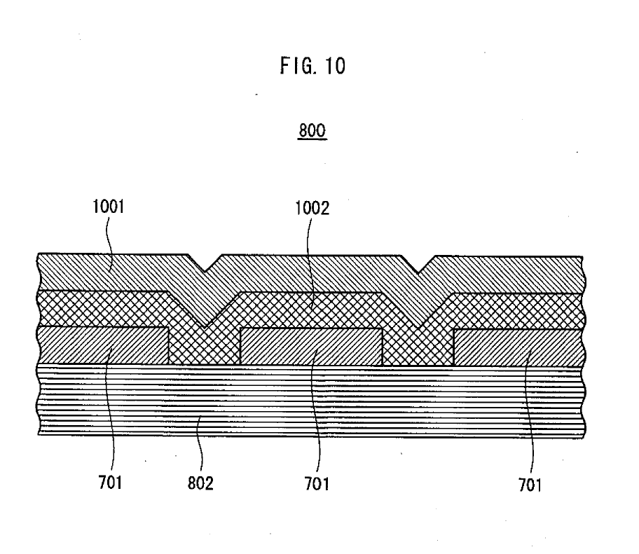

FIG. 10 is a cross-sectional diagram of the printed coil 800. As shown, the printed coil 800 has a main surface, on which is formed the coil pattern wire 701 of the polyimide film 802, connected to a coverlay 1001 by a connecting layer 1002.

The connecting layer 1002 reaches as far as the gaps between the coil pattern wires 701. Such a printed coil 800 can be procured by, for example, mounting the contact surface of the coverlay 1001, to which a polyimide-based adhesive has been applied, on the main surface formed by the coil pattern wire 701 on the polyimide film 802, and then laminating through heat and pressure.

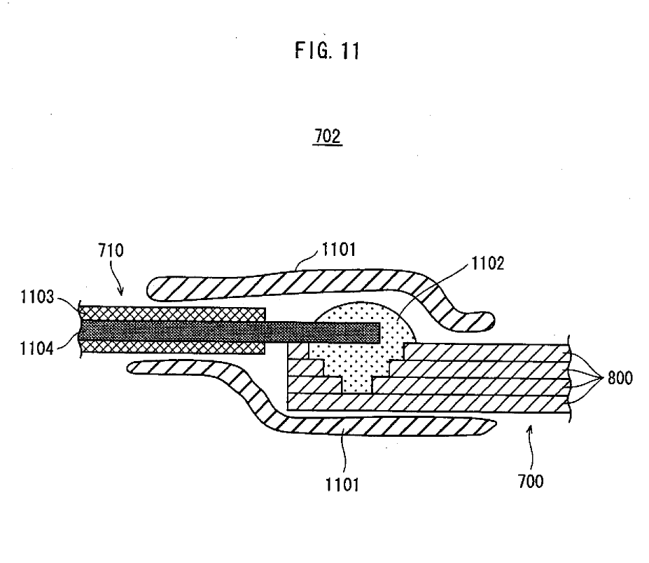

FIG. 11 is a cross-sectional diagram showing the structure of the connecting electrode 702. As shown, the connecting electrode 702 has the exposed wire portions 811b of all the printed coils 800 forming the printed coil set 700 soldered to a conductor 1004 of the wiring cable 710 by solder 1102. Also, unsoldered portions of the conductor 1004 are covered by an insulating material 1003. The soldered portions are covered by an insulating tube 1101. In addition to solder, silver brazing may be used to connect the exposed wiring portions 801 to the conductor 1004. Silver brazing is ideal given its high heat resistance.

### 4. DEMAGNETIZING ATTRIBUTES

The demagnetizing attributes of the demagnetizing coils 215 pertaining to the present invention are described next.

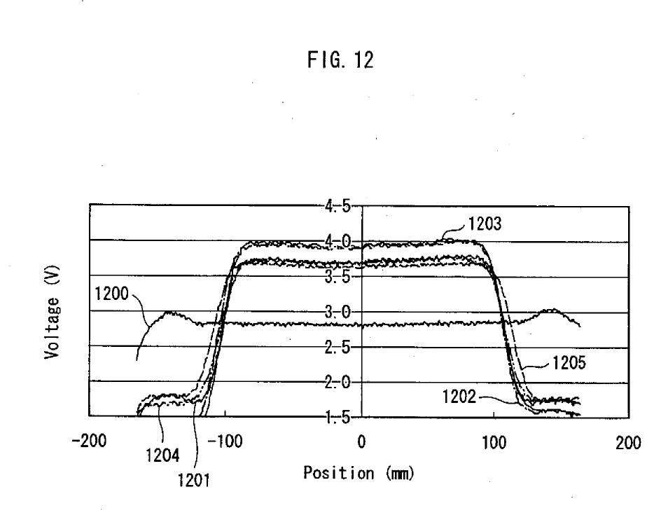

FIG. 12 is a graph illustrating magnetic field properties resulting from a plurality of demagnetizing coils being overlaid. The vertical axis indicates the distance of the fixing belt 206 axis of rotation from a central point, while the horizontal axis indicates magnetic field strength. As shown, when no demagnetizing coil is used, then as illustrated by graph line 1200, the magnetic field strength is nearly flat, being distributed over the entire active heating length of the magnetizing coil 207.

Here, graph line 1205 indicates the magnetic field strength obtained by using a demagnetizing coil pertaining to conventional technology. As shown, the magnetic field strength grows over the sheet-passing portion thereof matching the sheet-passing region, while being canceled out by the demagnetizing coils in the non-sheet-passing portion (where the demagnetizing coils are arranged), and thus decreasing precipitously.

Graph lines 1201 through 1205 illustrate the magnetic field properties obtained by using the demagnetizing coils 215 having a printed coil set 700 in which are respectively overlaid 1, 2, 4, and 8 printed coils 800 pertaining to the present invention. As shown in FIG. 12, near-identical magnetic field distribution properties are obtained with demagnetizing coils and 2 to 8 overlaid printed coils 800.

Accordingly, overlaying a plurality of coils appears to produce no change in inductance. Thus, wire impedance is reduced, heating of the demagnetizing coils is diminished, and enhanced demagnetizing attributes are obtained by overlaying a number of coils matching the electric power flowing in the magnetizing coils.

### 5. VARIATIONS

Although the invention has been described above with reference to the Embodiment, the invention is, of course, not limited in this manner. The following variations may also be employed.

(1) In the above-described Embodiment, a plurality of printed coils 800 are electrically connected in parallel. However, the invention is, of course, not limited in this manner. The printed coils 800 may instead be electrically connected in series.

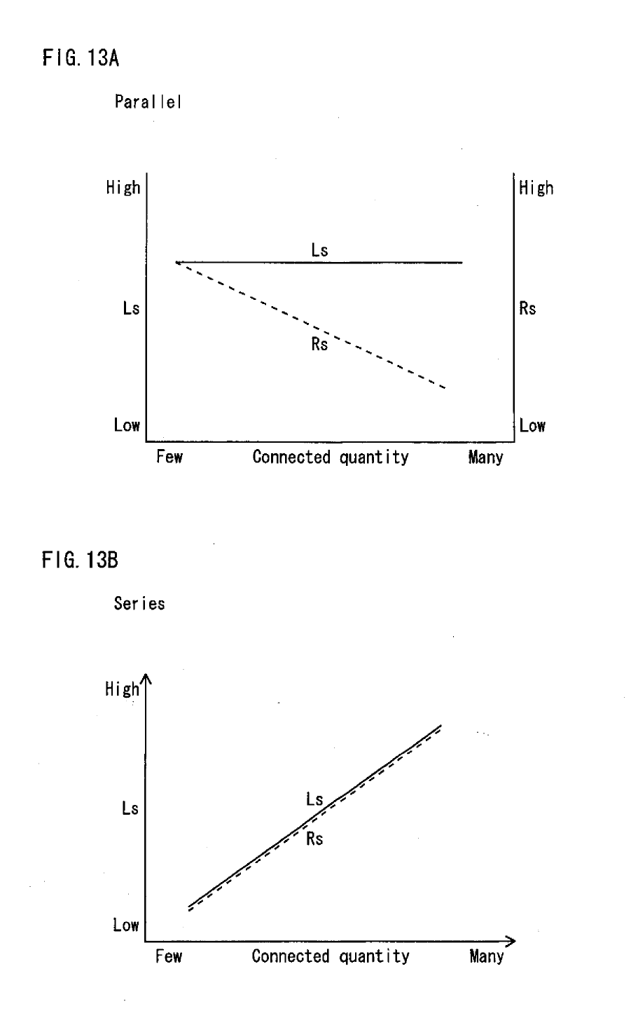

FIGS. 13A and 13B are graphs showing the relationship between the number of connected printed coils 800 and the inductance. In FIG. 13A, the coils are connected in parallel, while in FIG. 13B, the coils are connected in series. As shown in FIG. 13A, when the printed coils 800 are connected in series, the quantity of connected printed coils 800 causes no change in the inductance Ls of the demagnetizing coils 215 (attributes taken for the 20-40 kHz frequency band). On the other hand, the resistance Rs of the demagnetizing coils 215 decreases as the quantity of connected printed coils 800 increases.

Alternatively, as shown in FIG. 13B, when the printed coils 800 are connected in series, the inductance Ls and the resistance Rs of the demagnetizing coils 215 grow as the quantity of connected printed coils 800 increases.

Accordingly, the attributes of the demagnetizing coils 215 can be adjusted by making use of these properties and combining serial and parallel connections. This results in an induction heating unit 200 with attributes matching the intended use.

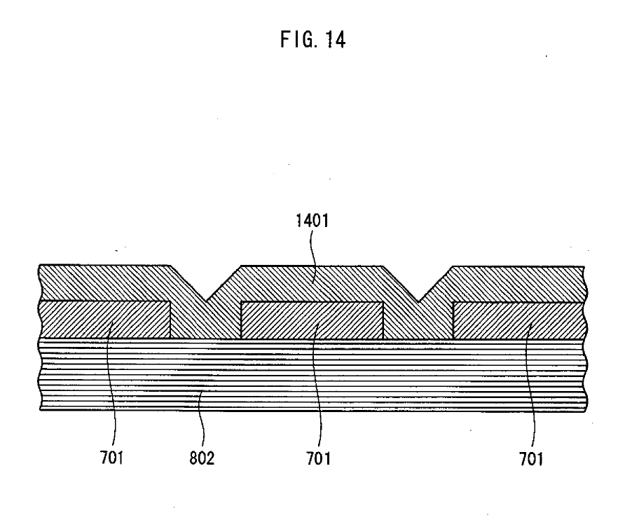

(2) In the above-described Embodiment, the coil pattern wire 701 is insulated and protected through the adhesion of the coverlay 1001, using an adhesive. Of course, the present invention is not limited in this manner. The following alternative is also possible. FIG. 14 is a cross-sectional diagram of a printed coil 800 pertaining to the variation. As shown, the coverlay 1401 may be formed by applying polyimide varnish and allowing it to dry.

Accordingly, by using polyimide varnish resistant to high temperatures (e.g., 300° C. and above), the coverlay 1401 is prevented from softening despite exposure to high-temperature environments (e.g., 200° C. and above) and the heat resistance of the printed coils 800 is enhanced. This enables use in a fixing apparatus, where the coils are exposed to high temperatures.

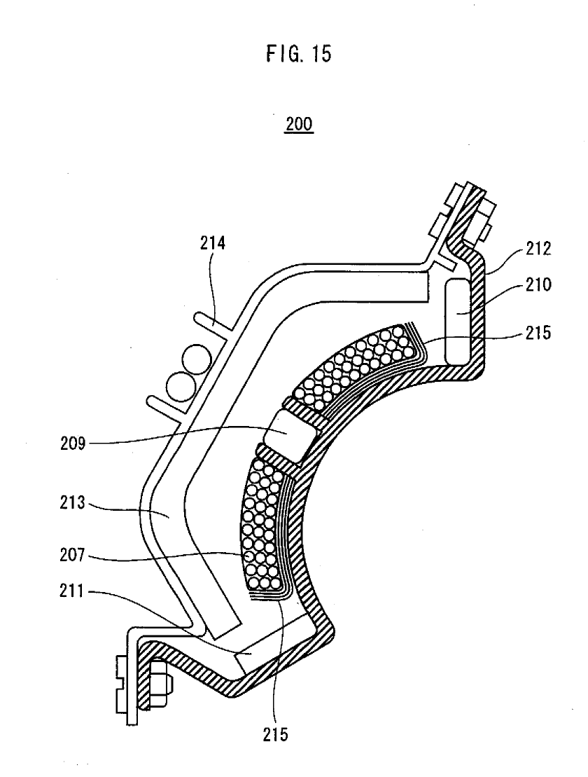

(3) In the above-described Embodiment, the demagnetizing coils 215 are disposed on the outside of the magnetizing coil 207, with respect to the radial direction of the fixing belt 206. Naturally, the present invention is not limited in this manner. The following alternative is also possible. FIG. 15 shows the configuration of an induction heating unit 200 pertaining to the present variation. As shown, the demagnetizing coils 215 included in the induction heating unit 200 are disposed on the inside of the magnetizing coil 207 with respect to the radial direction of the fixing belt 206 and curved along the circumferential direction of the fixing belt 206 so as to surround the outside of the magnetizing coil 207.

Accordingly, the demagnetizing coils 215 are made to approach the fixing belt 206 regardless of the magnetizing coil 207 thickness. Thus, reliably effective demagnetization is produced.

When the demagnetizing coils 215 are disposed on the inside of the magnetizing coil 207 with respect to the radial direction of the fixing belt 206, a recess may be provided in the coil bobbin 212 so as to contain the demagnetizing coils 215 therein. Thus, the surfaces of the coil bobbin 212 and the demagnetizing coils 215 that face the magnetizing coil 207 conform to the surface of the magnetizing coils 215. Accordingly, further miniaturization of the induction heating unit 200 is accomplished.

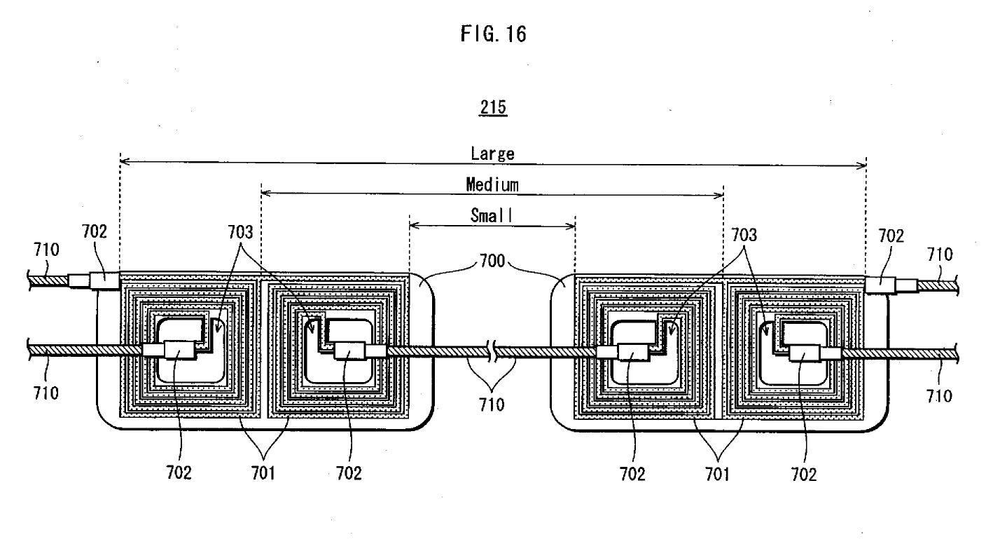

(4) In the above-described Embodiment, overheating of a specific non-sheet-passing region is prevented. Naturally, the present invention is not limited in this manner. The following alternative is also possible. FIG. 16 is a plan view showing the simplified configuration of the demagnetizing coils pertaining to the present variations. As shown, the demagnetizing coils 215 each include two printed coil sets 700 that, in turn, each include two coil patterns 701. Each pair of coil patterns 701 may be used simultaneously, or only the coil pattern 701 positioned closer to the outside with respect to the direction of the axis of rotation of the fixing belt 206 may be used. Accordingly, overheating can be prevented in non-sheet-passing regions corresponding to three sheet-passing sizes, i.e., small, medium, and large.

Naturally, the printed coil sets 700 are not limited to including two coil patterns 701. A single printed coil set 700 may also include three or more coil patterns 701.

Also, each printed coil set 700 may also be disposed so as to overlap with respect to the radial direction of the fixing belt 206. When one printed coil set 700 is formed of several coil patterns 701, the demagnetizing attributes are diminished at the border between coil patterns 701. There is thus a risk that overheating may not be effectively prevented in the non-sheet-passing region of the fixing belt 206. However, by having the printed coil sets 700 overlap, no borders form between the coil patterns 701, thus effectively preventing overheating in the non-sheet-passing region.

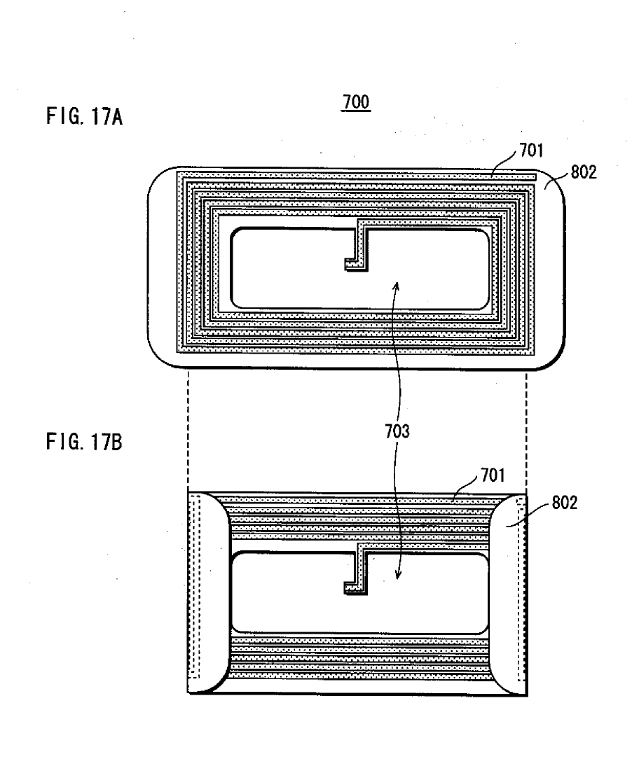

(5) In the above-described Embodiment, the printed coil set 700 is simply made to adhere to the magnetizing coil 207. Naturally, the present invention is not limited in this manner. The following alternative is also possible. FIGS. 17A and 17B show, in a plan view, the printed coil set 700 being processed before adhesion of the magnetizing coil 207. FIG. 17A show the printed coil set 700 before processing, and FIG. 17B shows the printed coil set 700 after processing.

As shown in FIG. 17B, after undergoing the processing pertaining to the present variation, each end of the printed coil set 700 has been folded with respect to the axis of rotation of the fixing belt 206. Accordingly, the demagnetizing coils 215 do not cover the magnetizing coil 207 at each end with respect to the axis of rotation of the fixing belt 206. Thus, the size of the induction heating unit 200 can be correspondingly reduced in the dimension of the axis of rotation.

(6) In the above-described Embodiment, the coil pattern wire 701 is formed on only one main surface of the printed coil 800. Naturally, the present invention is not limited in this manner. The printed coil 800 may also be formed on both main surfaces of the coil pattern wire 701. The same effects are obtained for the present invention regardless whether the coil pattern wire 701 is formed on a particular side or on both sides of the printed coil 800.
(7) Although not mentioned in the above-described Embodiment, the image forming apparatus pertaining to the present invention may be any of a copier, printer, or facsimile machine, or may be a Multi-Function Peripheral (MFP) incorporating several of these functions. Also, the images formed thereby may be monochrome or color. The apparatus may be connected to a network, or may be used as a standalone apparatus. As long as the image forming apparatus includes the induction heating unit pertaining to the present invention and thermally fixes images onto recording sheets in a plurality of sizes, the same effects are produced by using the present invention regardless of configuration and usage.

### 6. CONCLUSION

The induction heating unit pertaining to the present invention heats a conductive heat-producing rotating body through electromagnetic induction to thermally fix a toner image onto a recording sheet in one of a plurality of sizes, and comprises: a magnetizing coil, arranged along an outer circumferential surface of the heat-producing rotating body, heating the heat-producing rotating body through electromagnetic induction heating; and a demagnetizing coil, arranged in partially-overlapping proximity to the magnetizing coil, partially canceling out magnetic flux produced by the magnetizing coil to suppress overheating in a non-sheet-passing region of the heat-producing rotating body when fixing is performed on a recording sheet in one of the sizes that is not a largest size, wherein the demagnetizing coil includes a coil pattern printed on a flexible substrate, and the coil pattern has a wire of greater width than the separation between neighboring portions of the wire.

Accordingly, the coil pattern is printed on the flexible substrate, and the wires of the coil pattern are wider than the separation between neighboring portions while being arranged such that the demagnetizing coil is in partially-overlapping proximity to the magnetizing coil. The demagnetizing coil partially cancels the flux produced by the magnetizing coil and overheating is suppressed in the non-sheet-passing region of the heat-producing rotating body when fixing is performed on a recording sheet in a size that is not the largest. Thus, a fixing apparatus is provided in which low-cost miniaturization is achieved alongside highly-effective demagnetizing properties. This is due to the fact that a demagnetizing coil formed by printing a coil pattern on a flexible substrate is cheaper and lower-cost than a demagnetizing coil formed by winding a litz wire. Also, by widening the wire segment separation of the coil pattern, overheating is prevented in the demagnetizing coil and the demagnetizing properties are enhanced.

In these circumstances, the flexible substrate is ideally made of a thermally-resistant resin. The thermally-resistant resin may be a polyimide resin, and is preferably an aramid resin.

Alternatively, the fixing apparatus further comprises a coil bobbin, arranged between the heat-producing rotating body and the magnetizing coil, supporting the magnetizing coil, wherein the demagnetizing coil is sandwiched between the magnetizing coil and the coil bobbin. Accordingly, effective demagnetizing properties are achievable irrespective of the magnetizing coil thickness. Also, the number of turns in the coil pattern can be decreased because the inductance of the demagnetizing coil is reduced. Accordingly, if the coil pattern is widened, then the copper plating thickness can be reduced, thus reducing the labor and materials required to create the pattern. This enables reductions in the cost of materials for the induction heating unit.

Also, in these circumstances, the coil bobbin preferably has a recess housing the demagnetizing coil therein, and when the demagnetizing coil is being held in the recess of the coil bobbin, surfaces of the coil bobbin and the demagnetizing coil opposing the magnetizing coil are formed so as to conform to an opposite surface of the magnetizing coil.

Furthermore, in the fixing apparatus pertaining to the present invention, the demagnetizing coil includes a plurality of overlaid flexible substrates, each having the coil pattern printed thereon. In these circumstances, the coil patterns printed on each of the flexible substrates may be electrically connected in series, or may be connected in parallel. Accordingly, the inductance and electrical resistance of the demagnetizing coil are adjustable. As such, a fixing apparatus with usage-appropriate characteristics is provided.

Furthermore, in the fixing apparatus pertaining to the present invention, the base material of the flexible substrate is an insulating material. Accordingly, there is no need to arrange separate insulating material between the demagnetizing coil and the magnetizing coil or between the flexible substrates that make up the demagnetizing coil. This enables closer adhesion within the magnetizing coil and leads to improved demagnetization characteristics. Also, cost reductions are derived from the reduced number of parts needed for the induction heating unit.

Furthermore, the image forming apparatus pertaining to the present invention includes a fixing apparatus, the fixing apparatus comprising: a magnetizing coil, arranged along an outer circumferential surface of the heat-producing rotating body, heating the heat-producing rotating body through electromagnetic induction heating; and a demagnetizing coil, arranged in partially-overlapping proximity to the magnetizing coil, partially canceling out magnetic flux produced by the magnetizing coil to suppress overheating in a non-sheet-passing region of the heat-producing rotating body when fixing is performed on a recording sheet in one of the sizes that is not a largest size, wherein the demagnetizing coil includes a coil pattern printed on a flexible substrate, and the coil pattern has a wire of greater width than the separation between neighboring portions of the wire. Accordingly, the effects of the fixing apparatus pertaining to the present invention are obtained.

Also, the fixing apparatus pertaining to the present invention heats a conductive heat-producing rotating body through electromagnetic induction to thermally fix a toner image onto a recording sheet in one of a plurality of sizes, and comprises: a magnetizing coil heating the heat-producing rotating body through electromagnetic induction heating; and a demagnetizing coil, arranged in partially-overlapping proximity to the magnetizing coil, partially canceling out magnetic flux produced by the magnetizing coil to suppress overheating in a non-sheet-passing region of the heat-producing rotating body, wherein the demagnetizing coil includes a coil pattern printed on a flexible substrate, and the coil pattern has a wire of greater width than the separation between neighboring portions of the wire. Accordingly, an induction heating unit that is small in size and features great demagnetizing attributes is provided at low cost.

Although the present invention has been fully described by way of examples with reference to the accompanying drawings, it is to be noted that various changes and modifications will be apparent to those skilled in the art.

Therefore, unless otherwise such changes and modifications depart from the scope of the present invention, they should be construed as being included therein.

What is claimed is:

1. A fixing apparatus that heats a conductive heat-producing rotating body through electromagnetic induction to thermally fix a toner image onto a recording sheet in one of a plurality of sizes, comprising:
a magnetizing coil, arranged along an outer circumferential surface of the heat-producing rotating body, heating the heat-producing rotating body through electromagnetic induction heating; and
a demagnetizing coil, arranged in partially-overlapping proximity to the magnetizing coil, partially canceling out magnetic flux produced by the magnetizing coil to suppress overheating in a non-sheet-passing region of the heat-producing rotating body when fixing is performed on a recording sheet in one of the sizes that is not a largest size, wherein
the demagnetizing coil includes a coil pattern printed on a flexible substrate, and
the coil pattern has a wire of greater width than the separation between neighboring portions of the wire.

2. The fixing apparatus of claim 1, wherein
the flexible substrate is made of a thermally-resistant resin.

3. The fixing apparatus of claim 2, wherein
the thermally-resistant resin is a polyimide resin.

4. The fixing apparatus of claim 2, wherein
the thermally-resistant resin is an aramid resin.

5. The fixing apparatus of claim 1, further comprising a coil bobbin, arranged between the heat-producing rotating body and the magnetizing coil, supporting the magnetizing coil, wherein
the demagnetizing coil is sandwiched between the magnetizing coil and the coil bobbin.

6. The fixing apparatus of claim 5, wherein
the coil bobbin has a recess housing the demagnetizing coil therein, and
when the demagnetizing coil is being held in the recess of the coil bobbin, surfaces of the coil bobbin and the demagnetizing coil opposing the magnetizing coil are formed so as to conform to an opposite surface of the magnetizing coil.

7. The fixing apparatus of claim 1, wherein
the demagnetizing coil includes a plurality of overlaid flexible substrates, each having the coil pattern printed thereon.

8. The fixing apparatus of claim 7, wherein
the coil patterns printed on each of the flexible substrates are electrically connected in series.

9. The fixing apparatus of claim 7, wherein
the coil patterns printed on each of the flexible substrates are electrically connected in parallel.

10. The fixing apparatus of claim 1, wherein
the base material of the flexible substrate is an insulating material.

11. An image forming apparatus that includes a fixing apparatus, the fixing apparatus comprising:
a magnetizing coil, arranged along an outer circumferential surface of the heat-producing rotating body, heating the heat-producing rotating body through electromagnetic induction heating; and
a demagnetizing coil, arranged in partially-overlapping proximity to the magnetizing coil, partially canceling out magnetic flux produced by the magnetizing coil to suppress overheating in a non-sheet-passing region of the heat-producing rotating body when fixing is performed on a recording sheet in one of the sizes that is not a largest size, wherein
the demagnetizing coil includes a coil pattern printed on a flexible substrate, and
the coil pattern has a wire of greater width than the separation between neighboring wire segments.

12. An induction heating unit in a fixing apparatus that heats a conductive heat-producing rotating body through electromagnetic induction to thermally fix a toner image onto a recording sheet in one of a plurality of sizes, comprising:
a magnetizing coil heating the heat-producing rotating body through electromagnetic induction heating; and
a demagnetizing coil, arranged in partially-overlapping proximity to the magnetizing coil, partially canceling out magnetic flux produced by the magnetizing coil to suppress overheating in a non-sheet-passing region of the heat-producing rotating body, wherein
the demagnetizing coil includes a coil pattern printed on a flexible substrate, and
the coil pattern has a wire of greater width than the separation between neighboring wire segments.
